(19) United States
(12) Patent Application Publication
(10) Pub. No.: US 2010/0083242 A1
(43) Pub. Date: Apr. 1, 2010

(54) INSTALLATION MANAGEMENT SYSTEM FOR AN AIRCRAFT SERVER

(76) Inventors: Kai Altstaedt, Schenefeld (DE); Thomas Obert, Hamburg (DE)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/570,749

(22) Filed: Sep. 30, 2009

Related U.S. Application Data
(60) Provisional application No. 61/101,312, filed on Sep. 30, 2008.

(51) Int. Cl. G06F 9/445

(52) U.S. Cl. 717/169

(57) ABSTRACT

The present invention provides an installation management system for an aircraft server. In this case, the server comprises an installation data memory for storing at least one installation data pack. When updating installation files of the installation data pack, the installation files to be updated are overwritten by respective modified installation files. These modified installation files are contained in an installation service pack which is loaded by the aircraft server.

### RELATED APPLICATIONS

This application claims the benefit of U.S. Provisional Application No. 61/101,312, filed Sep. 30, 2008, the entire disclosure of which is herein incorporated by reference.

### TECHNICAL BACKGROUND

The invention relates to a system and method for partially updating installation data packs in an aircraft server.

A plurality of servers are contained in an aircraft and carry out various tasks. An example of a server of this type is a passenger application server which provides various passenger applications at terminals within the passenger cabin for aircraft passengers. There is also a server for the aircraft crew, in particular for the pilots, which provides manuals or instructions for example for the aircraft crew. Each stand-alone server inside the aircraft consists of a plurality of software components in addition to the hardware.

FIG. 1 shows various software components of a passenger application server in accordance with the prior art. Each software component is clearly identified by an identification number or part number (PN). An installation data memory of the server is partitioned or divided into a plurality of memory regions, it being possible to address each memory region using a functional identity number (FIN). The functional identity number denotes a target installation location of a unit or a load inside the aircraft. In this case, load means a clearly identifiable data volume, i.e. programs or files, which are to be installed on a server of the aircraft. In the simple example of a passenger application server shown in FIG. 1, said server comprises an operating system (OS), configuration data of the operating system, passenger applications and configuration data of the passenger applications as software components. The passenger applications consist, for example, of multimedia service applications which are paid for by credit card or the like. The configuration data of the passenger applications comprise, for example, the display of a logo or respective airline on a screen of a passenger terminal. The respective FIN denotes the partitioned memory region which is provided for the respective software component.

Various requirements must be taken into account when separating the server store for the various software components, in particular the field loadable software, into various memory regions which can each be addressed by a FIN. The various software components comprise different anticipated life cycles and update rates. Furthermore, executable operational software is stored separately from the configuration data and the data content. The modularity of the product offered must also be taken into account. Other criteria are different transfer speeds and loading and saving times for different software components. In order to achieve simple configuration and installation management, a low number of separated memory regions which are each denoted by a FIN is desired. However, the flexibility of the system decreases as the number of separate memory regions for the various software components increases in such a way that it may no longer be possible to provide the customer, i.e. the airline, with all desired constellations.

During operation of an aircraft server, for example a passenger application server, it may be the case that one or more installation data packs (IDP) must be refreshed or updated. If, for example, a passenger application server hacker manages to access passenger applications without having to pay for them, for example with a credit card, a safety or security update of the passenger application server must take place. A security update of this type for protecting the entire passenger system must be carried out as soon as possible, i.e. preferably at the aircraft's next intermediate stop at an airport.

FIG. 2 illustrates the conventional procedure for updating or refreshing an installation data pack IDP. An installation data pack IDP is arranged in an installation data memory of an aircraft server and comprises a plurality of installation files (ID). A FIN is assigned to the installation data pack IDP, i.e. the installation data pack IDP is arranged in the memory region of the partitioned data store of the server assigned to said FIN. An installation data pack IDP comprises, for example, all installation files ID of the operating system OS of a passenger application server. In the case of the conventional procedure, in order to update an installation data pack IDP of a target unit, for example of an aircraft server inside an aircraft, all installation data or installation files of the installation data pack are overwritten with installation files of the updated version of the installation data pack. In the example shown in FIG. 2, the installation data pack only comprises three installation files ID1, ID2, ID3. In actual fact, an installation data pack IDP often contains a much higher number of installation files ID. In order to update the installation data pack, in the case of the conventional procedure, a mobile data carrier, for example a CD or a USB stick is read out by the server via an interface and the previous installation data pack is overwritten using the part number (PN). The installation files ID of the respective installation data pack IDP are located, for example, in a primary store of the server, for example on a hard drive of the server and are replaced with the up-to-date installation files.

The conventional method for updating the installation data pack IDP or a software component of an aircraft server poses the drawback, however, that an update of this type takes a relatively long time. An installation data pack IDP may comprise a plurality of installation files ID and may have a large memory, for example of 800 MB. If the entire aircraft server is at risk, for example owing to an attack from a hacker, the respective installation data pack IDP of the software component must be updated with a security update at the next intermediate stop of the aircraft on the ground within a relatively short time window of 45 minutes for example. Owing to the size of the installation data packs IDP, the time available on the ground may not be sufficient to reliably carry out a security update.

It is thus an object of the present invention to provide an installation management system and a method for updating an installation data pack, in which an installation data pack of an aircraft server can be reliably updated in a short space of time.

### SUMMARY

The invention provides an installation management system for an aircraft server which comprises an installation data memory for storing at least one installation data pack, in which in order to update at least one installation file of the installation data pack, said installation file to be updated is overwritten by a respective modified installation file which is contained in an installation service pack or service pack which is loaded by the aircraft server.

The installation service pack is preferably on a mobile data carrier.

The installation management system according to the invention offers the advantage that it is easily for maintenance staff to use. The transfer or update time is significantly reduced with the installation management system according to the invention.

In one embodiment of the installation management system according to the invention, the installation data memory of the aircraft server comprises a plurality of memory regions which can each be addressed by a functional identity number.

The installation management system according to the invention has the advantage that an existing system can easily be expanded by implementing the installation management system according to the invention.

In one embodiment of the installation management system according to the invention, an installation data pack is saved in each memory region of the installation data memory, which installation data pack is identified by a part number.

In one embodiment of the installation management according to the invention, each up-to-date installation service pack or service pack loaded to form part of an installation data pack contains up-to-date modified installation files for the installation files of the respective installation data pack to be updated as well as for the modified installation files of all previous installation service packs or service packs already used to partly update the same installation data pack.

In one embodiment of the installation management system according to the invention, an additional memory region is provided in the installation data memory for each partially updatable installation data pack, in which additional memory region the most up-to-date installation service pack or service pack for said updatable installation data pack is stored.

In one embodiment of the installation management system according to the invention, the installation data pack comprises installation files for program data and/or installation files for configuration data.

In one embodiment of the installation management system according to the invention, the mobile data carrier is a USB flash drive, a CD-ROM or a memory card.

In an alternative embodiment of the installation management system according to the invention, the mobile data carrier is a data memory of a mobile service device.

In one possible embodiment of the installation management system according to the invention, the mobile service device is a portable notebook.

The invention also provides an aircraft server comprising an installation file memory which stores at least one installation data pack which contains a plurality of installation files and is connected to an interface for loading an installation service pack or service pack, in which in order to partially update a saved installation data pack with the at least one installation file of the installation data pack, the installation file to be updated is overwritten by an up-to-date modified installation file which is contained in an installation service pack or service pack which is loaded via an interface.

The invention further provides a method for partially updating an installation data pack comprising a plurality of installation files which are saved on an installation file memory of an aircraft server, in which in order to update at least one installation file of the installation data pack, said installation file to be updated is overwritten by a respective up-to-date modified installation file which is contained in an installation service pack or service pack which is loaded by the aircraft server.

The invention further provides an installation program for partially updating an installation data pack with program commands for carrying out a method of this type.

The invention further provides a computer program product for saving a computer program of this type.

### BRIEF DESCRIPTION OF THE DRAWINGS

Embodiments of the installation management system and method according to the invention for partially updating an installation data pack are described hereinafter with reference to the accompanying drawings, in which:

FIG. 1 is a table illustrating a possible memory partitioning in a conventional passenger application server in accordance with the prior art;

FIG. 2 is a diagram explaining the conventional method for updating an installation data pack in accordance with the prior art;

FIG. 3 shows an embodiment of an installation management system according to the invention;

FIG. 4 is a detail of the installation management system shown in FIG. 3;

FIG. 5 is a diagram for explaining the installation management system according to the invention;

FIG. 6 is an example of an update step in the installation method according to the invention;

FIG. 7 is an example of another update step in the installation method according to the invention;

FIG. 8 is an exemplary memory partitioning in a passenger application server.

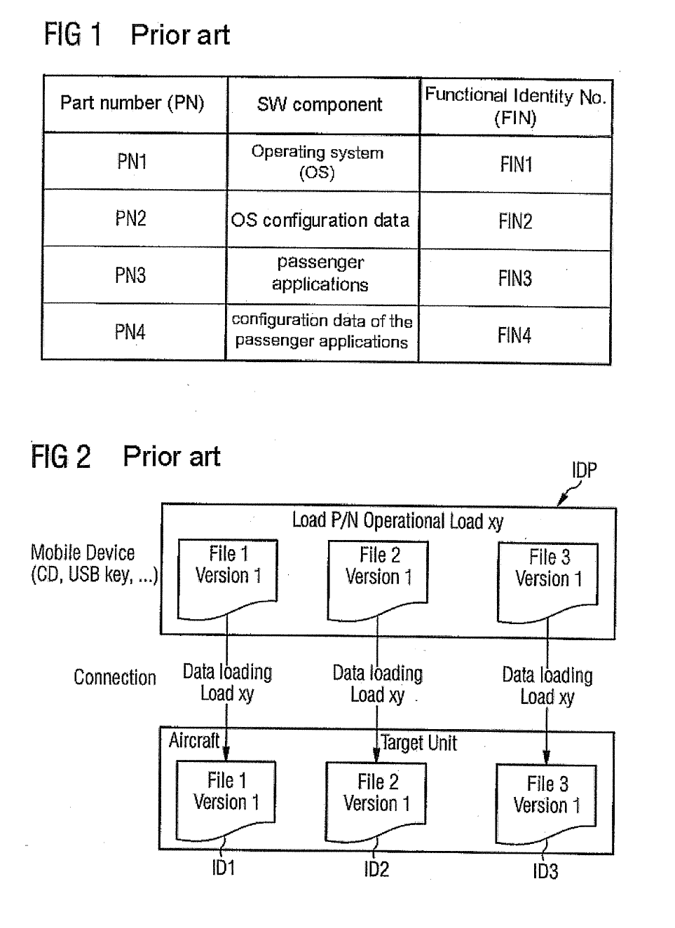

### DETAILED DESCRIPTION OF EMBODIMENTS

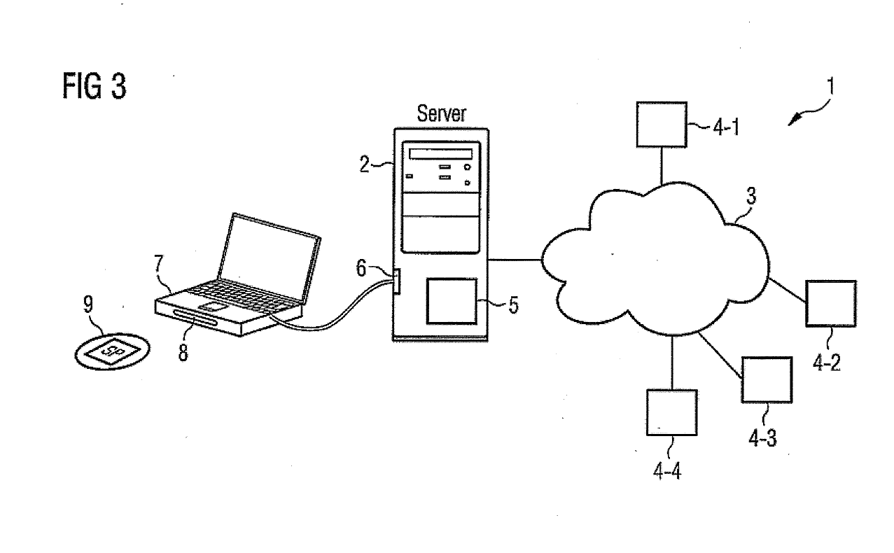

As can be seen from the embodiment shown in FIG. 3, an installation management system 1 comprises, in accordance with the invention, a server 2 which is a stand-alone server inside an aircraft. The aircraft server 2 may be connected to a local network 3 having a plurality of client computers 4. The aircraft server 2 is, for example, a passenger application server which operates various terminals 4-i inside a passenger cabin. The aircraft server 2 comprises an installation file memory 5 in which at least one installation data pack IDP is located. The installation file memory 5 may be a primary repository of the server 2. The installation file memory 5 is preferably a hard drive of the server 2. In the embodiment shown in FIG. 3, the server 2 comprises an interface 6 to which a mobile service device 7, for example a portable notebook, can be connected. The service device 7 comprises a unit 8 for reading in and reading out a data carrier 9. An installation service pack or service pack SP is saved on the data carrier 9. The data carrier 9 may be, for example, a CD, a USB stick or a DVD. In an alternative embodiment, the data carrier 9 may be inserted directly into a reading unit of the server 2 so no external service device is necessary.

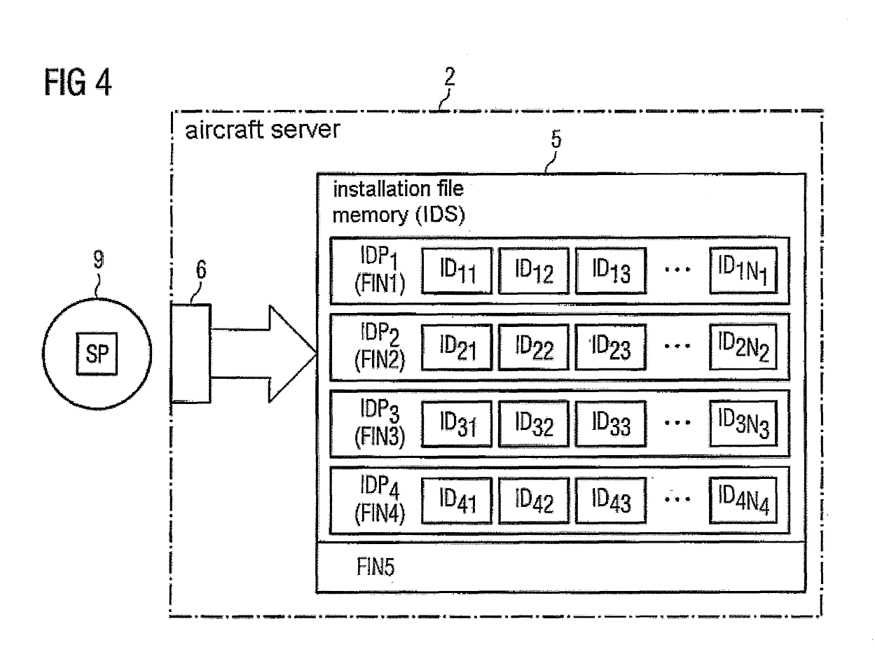

FIG. 4 shows systematically the saving of a plurality of installation data packs IDP in various memory regions of an installation data memory 5. The installation data memory 5 is formed by a hard drive for example. The installation data memory 5 is partitioned, it being possible to address each of the various memory regions by a functional identity number FIN. An installation data pack IDP is saved in each partitioned memory region. Each installation data pack IDP comprises a plurality of installation files ID. An installation data pack IDP comprises, for example installation files for program data or installation files for configuration data. Each installation data pack IDP forms a software component of the respective aircraft system.

The aircraft server 2 according to FIG. 4 is for example a passenger application server or a server for the aircraft crew. Each software component or each installation data pack IDP comprises a part number or PN. The first installation data pack IDP1 is, for example, executable programs of an operating system OS for the passenger application server 2. The second installation data pack IDP2 is formed by the configuration data of the operating system OS for example. The third installation data pack IDP3 is passenger applications or executable program files of passenger application for example. The fourth installation data pack IDP4 is configuration data for passenger applications of this type for example.

In a possible embodiment of the aircraft server 2 according to the invention, an additional memory region is provided inside the partitioned installation data memory 5 for each partially updatable installation data pack IDP, in which additional memory region the most up-to-date installation service pack SP for said updatable installation data pack IDP can be saved. In the simple embodiment shown in FIG. 4, the installation data pack IDP1 is partially updatable and an additional memory region for a respective installation service pack or service pack SP is provided in the installation data memory 5, which additional memory region can be addressed by its own functional identity number FIN 5.

In the installation management system 1 according to the invention, in order to update at least one installation file ID of the installation data pack IDP to be updated, said installation file ID to be updated is overwritten by a respective modified installation file which is contained in an installation service pack or service pack SP which can be loaded by the aircraft server 2 from a mobile data carrier 9.

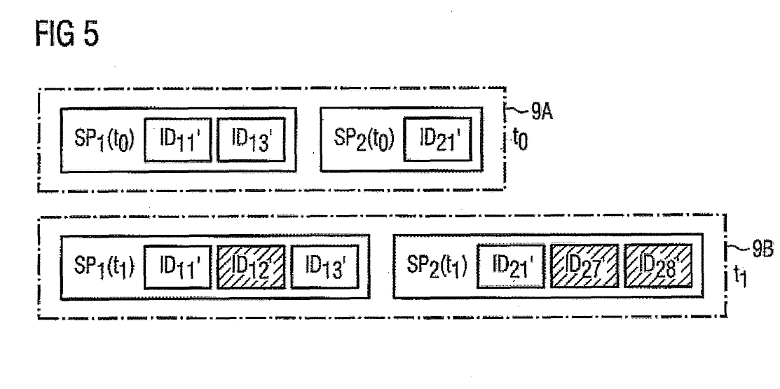

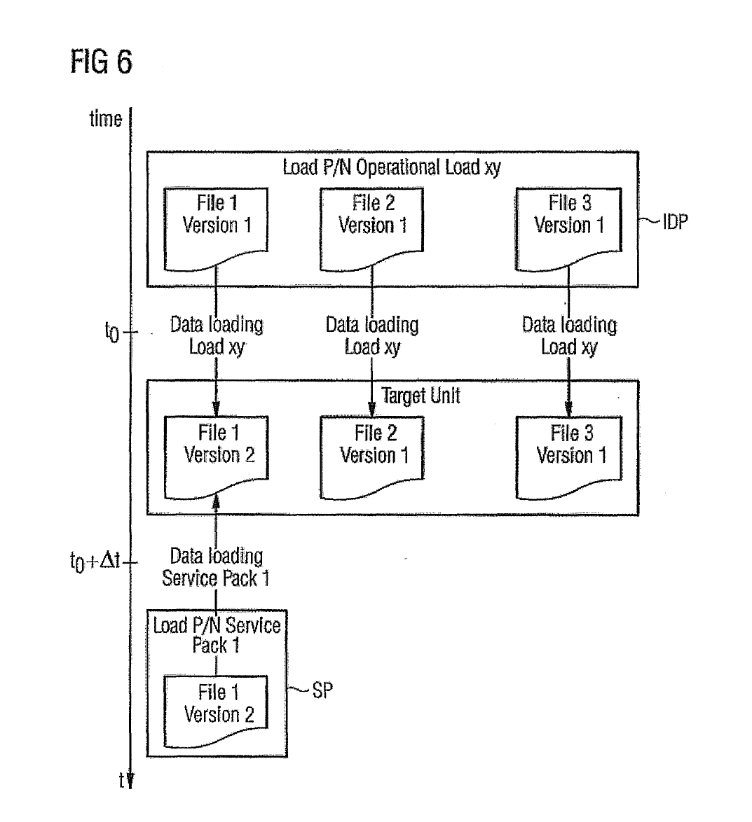

FIG. 5 shows a diagram illustrating an update process by way of a simple example. In the example shown in FIG. 5, the installation files ID₁ and ID₁₃ inside the first installation data pack IDP1 and the installation file ID₂₁ within the second installation data pack IDP2 are to be updated. In order to update the two installation data packs IDP1, IDP2, two respective installation service packs SP1 and SP2 are thus prepared and saved in the mobile data carrier 9. The two installation service packs SP1, SP2 contain the updated version of the installation files ID′.

As soon as the aircraft has landed, in order to carry out a security update at the moment t0 a mobile data carrier 9A is read out directly or with the aid of a mobile service device, the installation files ID to be updated of the respective installation data pack IDP being overwritten by the respective modified installation file ID′ which is located in an installation service pack SP associated with the respective installation data pack IDP. In the simple example shown in FIG. 5, the two installation files ID₁₁ and ID₁₃ to be updated are thus overwritten in the first installation data pack IDP1 by the installation files ID₁₁′ and ID₁₃′ contained in the service pack or installation service pack SP. The installation data pack IDP2 is updated in a similar manner, in that the installation file ID₂₁ is overwritten by the installation file ID21′ of the respective installation service pack SP2. In the method according to the invention, it is thus no longer the case that all of the installation files ID of the installation data pack IDP are overwritten in order to refresh or update an installation data pack IDP, but only those installation files which are to be updated are overwritten. For example, it is thus no longer the case that all of the installation files ID₁₁ to ID_{1N1} of the installation data pack IDP1, for example of the operating system OS, are no longer overwritten, but only the necessary installation files which are to be overwritten, for example ID₁₁ and ID₁₃ are updated. Since only a limited number of installation files ID need to be transferred from the data carrier, the time necessary for updating an installation data pack IDP, for example of the operating system OS, is considerably reduced. In the case of a typical installation data pack IDP with a plurality of installation files ID, which has a memory volume of 800 MB for example, the update process according to the invention reduces the required update time, which was originally more than 40 minutes with the conventional method, to 1 to 5 minutes with the update method according to the invention.

So as to be able to update the installation data pack IDP in an incremental manner, in the installation management system 1 according to the invention for partially updating an installation data pack IDP a loaded up-to-date installation service pack SPi comprises up-to-date modified installation files ID′ for the installation files ID to be updated of the respective installation data pack IDP and also comprises the modified installation files ID′ of all previous installation service packs SP₁ to SPᵢ₋₁ used to partially update the same installation data pack IDP. In the simple example shown in FIG. 5, at the moment in time t1 a further incremental update of the two installation data packs IDP1, IDP2 is carried out. In this further incremental update step, in the given example the installation files ID₁₂ of the first installation data pack IDP1 are updated with the installation files ID₂₇, ID₂₈ of the second installation data pack IDP2. In order to update the two installation data packs IDP1, IDP2, two service packs or two installation service packs SP1, SP2 are input from a data carrier 9B. The service packs or installation service packs SP thus also contain the installation files of the previous service packs or installation service packs SP. At the moment in time t1, the service pack or installation service pack SP1 thus comprises not only the installation file ID₁₂′, but also the two modified installation files ID₁₁′ and ID₁₃′ used at the moment in time t0 to update for example. The second service pack or installation service pack SP2 contains not only the up-to-date required modified installation files ID′27 and ID′28, but also the installation file ID₂₁′ already obtained at the moment in time tO in the service pack.

In the example in FIG. 5, two service packs or installation service packs SP1, SP2 are input from a first data carrier 9A at the moment in time t0 during a first intermediate stop of the aircraft and two further service packs or installation service packs SP are input from a data carrier 9B at a later moment in time t1.

FIG. 6 shows a further simple example illustrating an update process. In the example shown here, an installation data pack IDP comprises three data files. At a moment in time t0, the installation data pack IDP is updated during a service process. At a moment in time t0+Δt, the installation data pack IDP is partially updated in accordance with the installation method according to the invention during an intermediate stop of the aircraft. During this partial update, only the modified installation files are loaded. In the example shown in FIG. 6, the service pack or installation service pack SP1 only contains an up-to-date modified installation file ID1′.

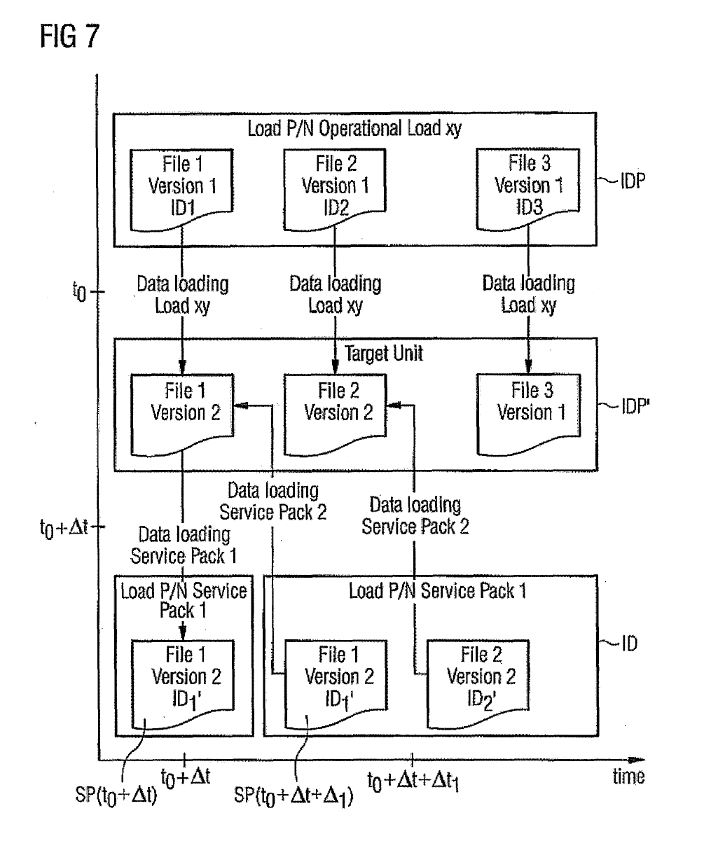

FIG. 7 shows a further incremental update step in the example shown in FIG. 6. At a moment in time t0+Δt+Δt1, a further partial update of the installation data pack IDP is carried out, for example during another intermediate stop of the aircraft. As can be seen in FIG. 7, the second installation service pack SP2 comprises not only the up-to-date version for the second installation file ID2, but also the modified installation file ID1′ contained in the first service pack or installation service pack SP1.

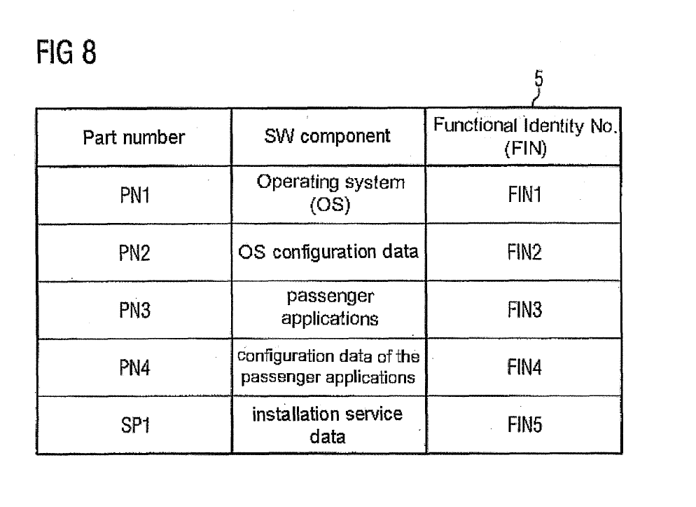

FIG. 8 shows a possible memory arrangement of an installation data memory 5 in an installation data management 1 according to the invention. In the example shown in FIG. 8, the memory 5 contains a plurality of software components which each form an installation data pack IDP. The four installation data packs IDP are the operating system OS of the passenger application server, configuration data for said operating system, passenger applications and configuration data of the passenger applications. In the example shown in FIG. 8, only one of the installation data packs IDP, namely the first software component, i.e. the operating system OS, is incrementally updatable. In alternative embodiments, a plurality of installation data packs IDP can be updated incrementally. Each of the installation data packs IDP1 to IDP4 is located in a respective partitioned memory region which can be addressed by a functional identity number FIN1 to FIN4. In addition, each installation data pack IDP4 to IDP4 can be identified by a part number PN1 to PN4. An appropriate partitioned memory region is provided in the memory 5 for each partially updatable installation data pack IDP, which partitioned memory region can also be addressed by functional identity number FIN. In the embodiment in FIG. 8, a memory region for the installation service data files or service packs SP is provided for the individual partially updatable installation data pack IDP, i.e. for the operating system OS, it being possible to address said memory region using its own functional identity number FIN5. The last or most up-to-date installation service pack SP for the operating system OS is written into said memory region.

In order to ensure a controlled configuration or installation, the following rules should be observed with the installation management system 1 according to the invention:

When loaded, a specific service pack or installation service pack SP only influences a software component of which a partitioned memory region is addressed by no other functional identity number FIN.

The service pack or installation service pack SP is ancillary, i.e. in addition to the up-to-date required modified installation files ID′, it also contains the installation files to be updated of the installation data pack and also the modified installation files of all previous installation service packs SP used to partially update the same installation data pack IDP.

In the case of a complete update, for example during servicing, as is the case at the moment in time tO in FIGS. 6 and 7 for example, the service packs or installation service packs SP previously installed during an intermediate stop are removed or deleted. With the update method according to the invention, the average software loading time can be considerably reduced in such a way that complex installation data packs IDP having a large memory side can be updated within a relatively short space of time, for example during an intermediate stop of an aircraft. Furthermore, the installation management system 1 according to the invention offers simple handling and enables flexible partitioning for a wide range of applications and servers. The update according to the invention enables complex installation data packs to be updated in a controlled and incremental manner. Furthermore, the installation management system 1 according to the invention also enables simple certification since each change, no matter how small, is always carried out in a controlled and reproducible manner. The installation management system 1 according to the invention is also suitable for loading data from a remote data source (remote data loading).

The aircraft server 2 may be any server within an aircraft. In a possible variant, the aircraft server 2 comprises not only one installation data memory 5, as shown in FIG. 4, but a plurality of installation data memories. Data used to overwrite the installation files ID may be read directly from an inserted data carrier or indirectly by way of a service device. In one possible embodiment, the service device shown in FIG. 3 is not connected to the server 2 via a wired interface, but via a wireless interface. In a possible variant, the data is transferred in encoded form, the service device 7 containing an encoding unit and the server 2 decoding the service data by way of a decoding unit.

In a further possible variant, a serviceman enters the aircraft with a service device 7 and installs the up-to-date installation service pack SP onto the server 2. In an alternative embodiment, the installation service packs SP are installed via a wireless interface from a service device which is located outside the aircraft. In this case, the data are transferred in encoded form for security reasons. The installation of different installation service packs SP is preferably recorded so as to facilitate certification. The update method according to the invention is suitable for a stand-alone server of an autonomous passenger aircraft. The update method according to the invention is suitable for any type of flying device, for example also suitable for helicopters.

1. Installation management system for an aircraft server, which system comprises an installation data memory for storing at least one installation data pack, wherein in order to update at least one installation file of the installation data pack, said installation file to be updated is overwritten by a respective modified installation file which is contained in an installation service pack which is loaded by the aircraft server.

2. Installation management system according to claim 1, wherein the installation data memory of the aircraft server comprises a plurality of memory regions which can each be addressed by a functional identity number.

3. Installation management system according to claim 2, wherein an installation data pack is saved in each memory region of the installation data memory, which installation data pack is identified by a part number.

4. Installation management system according to claim 1, wherein each up-to-date installation service pack loaded in order to partially update an installation data pack comprises up-to-date modified installation files for the installation files to be updated of the respective installation data pack and for the modified installation files of all previous installation service packs used to partially update the same installation data pack.

5. Installation management system according to claim 1, wherein for each partially updatable installation data pack, an additional memory region is provided in the installation data memory, in which region the most up-to-date installation service pack is saved for said updatable installation data pack.

6. Installation management system according to claim 1, wherein the installation data pack comprises installation files for program data or installation files for configuration data.

7. Installation management system according to claim 1, wherein the installation service pack is loaded from a mobile data carrier.

8. Installation management system according to claim 7, wherein the mobile data carrier is a USB flash drive, a CD-ROM or a memory card.

9. Installation management system according to claim 7, wherein the mobile data carrier is a data memory of a mobile service device.

10. Installation management system according to claim 9, wherein the mobile service device is a portable notebook.

11. Aircraft server comprising an installation data memory which stores at least one installation data pack containing a plurality of installation files, and comprising an interface for loading an installation service pack, wherein in order to partially update a saved installation data pack in which at least one installation file of the installation data pack is updated, the installation file to be updated is overwritten by an up-to-date modified installation file which is contained in an installation service pack which is loaded via the interface.

12. Method for partially updating an installation data pack comprising a plurality of installation files which are saved in an installation data memory of an aircraft server, wherein in order to update at least one installation file of the installation data pack, said installation file to be updated is overwritten by a respective up-to-date modified installation file which is contained in an installation service pack which is loaded by the aircraft server.

13. Installation program for partially updating an installation data pack using program commands for carrying out the method according to claim 12.

14. Computer program product for saving the computer program according to claim 13.
